(19) United States
(12) Patent Application Publication
(10) Pub. No.: US 2020/0409573 A1
(43) Pub. Date: Dec. 31, 2020

(54) SYSTEM FOR PROVIDING HYBRID WORM DISK

(71) Applicant: NAMUSOFT CO., LTD, Seoul (KR)

(72) Inventors: Jong Hyun WOO, Seoul (KR); Min Sik MOON, Goyang-si, Gyeonggi-do (KR)

(73) Assignee: NAMUSOFT CO., LTD, Seoul (KR)

(21) Appl. No.: 16/979,875

(22) PCT Filed: Dec. 17, 2018
(86) PCT No.: PCT/KR2018/016029

§ 371 Date: Sep. 11, 2020

(30) Foreign Application Priority Data
Mar. 14, 2018 (KR) 10-2018-0029490
May 18, 2018 (KR) 10-2018-0057109

(51) Int. Cl. G06F 3/06; G06F 16/182; G06F 16/16; G06F 21/62

(52) U.S. Cl. CPC G06F 3/0622; G06F 3/0643; G06F 21/6218; G06F 16/183; G06F 16/16; G06F 3/067

(57) ABSTRACT

A system for providing a hybrid WORM disk, includes: a network file server; and a network file server (NFS) client installed in a user terminal or a service server and communicatively connected to the network file server which is located remotely from the NFS client, wherein the network file server has a mode setting function which allows a disk drive, which is mounted in the form of a network drive in the user terminal or the service server, to operate in any one of a general disk mode in which creating, reading, modifying, deleting, and the like are possible, and a Write Once Read Many (WORM) disk mode in which only creating and reading are possible.

### TECHNICAL FIELD

The present invention relates to an external attack blocking technology, and to a system for providing a hybrid WORM disk.

### BACKGROUND ART

As ransomware distributed by hackers become more and more diverse, users' data are increasingly threatened. The ransomware is an attack technique that requires money after encrypting data stored in a network storage which has been stored or connected to a user's terminal so as not to be accessible by the user. In recent years, there have been various methods and forms to preventing the user from using a PC terminal by manipulating a disk partition of the terminal from preventing the user from using the data after leaking the data.

As a conventional method corresponding to the ransomware attack, there is a method of periodically backing up data in a PC to a safe storage area and bringing and using the backed-up data even if the PC is infected with the ransomware. However, even by this method, there is a problem that the loss of files that have been recently worked can not be avoided. As another convention method, there is a method of registering a process of accessing a file server in advance and enabling only a process authorized in the PC to access the data, so as to block the data access when a process which is not registered in advance accesses the data, thereby preventing a ransomware process from accessing the data. However, this method has inconvenience to register the authorized process in advance, and there is a limitation in that the process cannot be registered cumbersomely every time when a program is installed frequently.

In recent years, there is even a case where the ransomware itself does not encrypt only the data stored in the PC, but encrypts the entire PC or encrypts the entire disk mounted on the PC to require ransom money. Thus, there is a situation that it is no longer enough to just prevent the encryption of the data. In addition, since there is an attack that encrypts not only the PC but also the entire data on the file server connected to the PC at once, a fundamental alternative is needed.

### DISCLOSURE

### Technical Problem

The present invention is derived to solve the above-described problems, and provides a system for blocking external attacks that provides a hybrid WORM disk so as to enable effective external attack blocking.

### Technical Solution

According to an aspect of the present invention, there is provided a system for providing a hybrid WORM disk, the system comprising: a network file server; and a network file server (NFS) client installed in a user terminal or a service server and communicatively connected to the network file server which is located remotely from the NFS client.

Here, the network file server has a mode setting function which allows a disk drive, which is mounted in the form of a network drive in the user terminal or the service server, to operate in any one of a general disk mode in which creating, reading, modifying, deleting, and the like are possible, and a Write Once Read Many (WORM) disk mode in which only creating and reading are possible. While the disk drive operates in the WORM disk mode, when the file creation request is received from the NFS client, the network file server checks whether a file with an identical filename exists and allows the corresponding file to be created within a preset change valid time range if no identical file exists.

In one embodiment, while the disk drive operates in the WORM disk mode, when the file creation request is received from the NFS client, the network file server may check whether an identical file exists based on a file creation requester identifier (ID), a file path, and a file name included in the file creation request, and allow the creation of the corresponding file within the change valid time range based on a first file creation request time of the corresponding file when the identical file exists.

In one embodiment, while the disk drive operates in the WORM disk mode, when any one file change request among writing, modifying, deleting, moving, and name changing of the file is received from the NFS client, the network file server may check whether a file requested to change the file exists, check whether the change valid time has elapsed if the corresponding file exists, allow the change according to the file change request if the change valid time has not elapsed, and reject the change according to the file change request to the NFS client if the change valid time has elapsed.

In one embodiment, while the disk drive operates in the WORM disk mode, when an open request for the corresponding file is received from the NFS client after the change valid time has elapsed, the network file server may provide the open-requested file only as read-only.

In one embodiment, any one of the general disk mode and the WORM disk mode may be able to be set for the entire disk drive, or separately set for each basic folder in the disk drive or for each subfolder in the basic folder.

In one embodiment, the change valid time may be able to be set independently for each type or attribute of the corresponding file or for each type or attribute of an application program of creating the corresponding file.

In one embodiment, while the disk drive operates in the WORM disk mode, when a process which is not registered in advance in the user terminal or the service server is detected, the network file server may block the disk drive mounted in the form of a network drive or prohibit the reading of files in the disk drive.

According to another aspect of the present invention, there is provided a detachable hybrid WORM disk comprising: a file server which is installed on a separate device from a computer on which a storage drive is to be mounted, mounted with a push server for transmitting a list of storage devices to be connected to the computer after querying a storage device connected in the device, and mounted with a product service for providing a drive service for each storage device when requesting a drive connection of a mount program in the computer; and mount program which is installed on the computer on which the drive is to be mounted, receives a list of storage devices to request a connection to the file server, requests the connection to the file server for each storage device, and receives a drive service.

In one embodiment, when the file server is connected to the computer, the file server may be able to be connected through an Ethernet network, or connected by switching the network to an emulated USB medium.

In one embodiment, when a USB storage is additionally connected to the file server, the file server may automatically recognize that the storage device is added and send additional storage information to the connected computer, and then, when the computer requests to mount a new device for automatic connection of an additional storage, the file server may connect the storage area to be mounted as a new drive on the computer.

In one embodiment, when the storage which has been connected to the file server is disconnected, the file server may recognize the disconnection of the storage, send information on the disconnected storage to the connected computer, and then unmount the drive which has been connected to the corresponding storage on the computer.

### Advantageous Effects

According to the system for providing the hybrid WORM disk of the embodiment of the present invention, it is possible to select a WORM disk mode and a general disk mode through the hybrid WORM disk to be mounted in the form of a network drive on a user terminal (a PC, etc.) or a service server. In addition, while the disk drive operates in the WORM disk mode, in a process of creating a new file, there is a limitation to perform the file creation or change within a preset change valid time based on the file creation request time, and thereafter, the disk drive operates only in a read-only mode, thereby effectively blocking external attacks such as ransomware, etc.

### DESCRIPTION OF DRAWINGS

FIG. 1 is an overall block diagram of a system for providing a hybrid WORM disk including a network file server and a PC on which a client program is installed.

FIGS. 2 and 3 are reference diagrams for describing a system for providing a hybrid WORM disk according to an embodiment of the present invention.

FIG. 4 is an example of an administrator page for setting a file change valid time.

FIG. 5 is an example of opening a file as read-only while a WORM disk mode is operated in the system for providing the hybrid WORM disk.

FIG. 6 is an example of a mode setting administrator page for each folder.

FIG. 7 is a conceptual diagram of an embodiment for describing a method and a system in which a computer and a file server are connected to a network constituted by a USB medium and a new external USB storage is connected to the file server to be automatically mounted on a computer as a network drive device.

FIG. 8 is a diagram of an embodiment for describing a configuration connected between a computer and a file server and a configuration to which a file server and a new storage are connected.

FIG. 9 is a flowchart illustrating how a product service and a push server driven in a file server receive a drive list and initiates a connection with a mount program driven in a computer.

### MODES OF THE INVENTION

The present invention may have various modifications and various embodiments and specific embodiments will be illustrated in the drawings and described in detail in the detailed description. However, this does not limit the present invention to specific embodiments, and it should be understood that the present invention covers all the modifications, equivalents and replacements within the idea and technical scope of the present invention.

In describing the present invention, a detailed description of related known technologies will be omitted if it is determined that the detailed description unnecessarily makes the gist of the present invention unclear. In addition, figures (for example, first, second, and the like) used during describing the present specification are just identification symbols for distinguishing one component from the other component.

Further, in the present specification, if it is described that one component is “connected to” or “accesses” the other component, it will be understood that the one component may be directly connected to or may directly access the other component, but unless explicitly described to the contrary, another component may be “connected” or “accessed” via another component therebetween.

Throughout the specification, unless explicitly described to the contrary, when any part “comprises” any component, it is meant that the part may further include another component without excluding another component. Further, terms of “unit”, “module”, and the like disclosed in the specification mean a unit that processes at least one function or operation, and this may be implemented by one or more hardware or software or a combination of hardware and software.

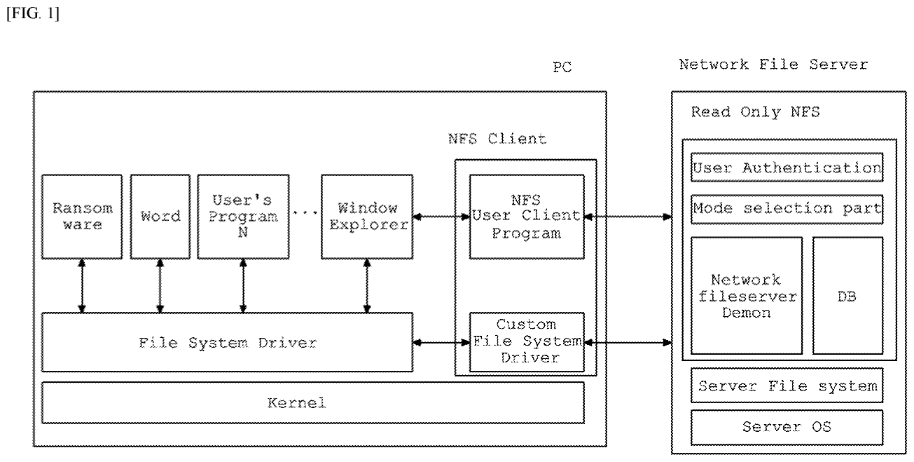

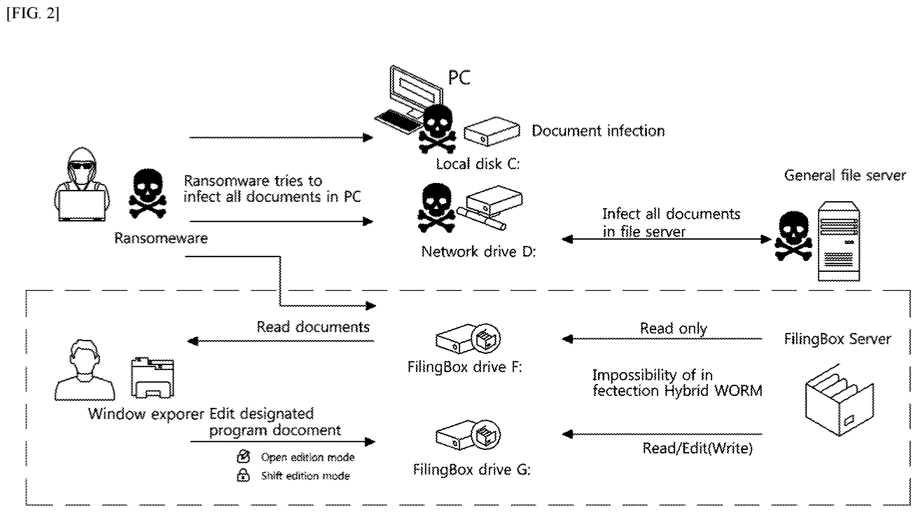

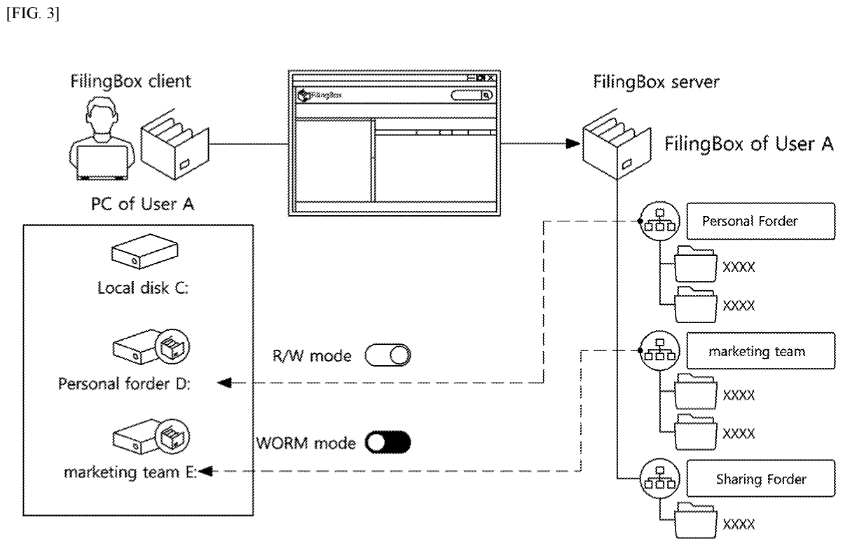

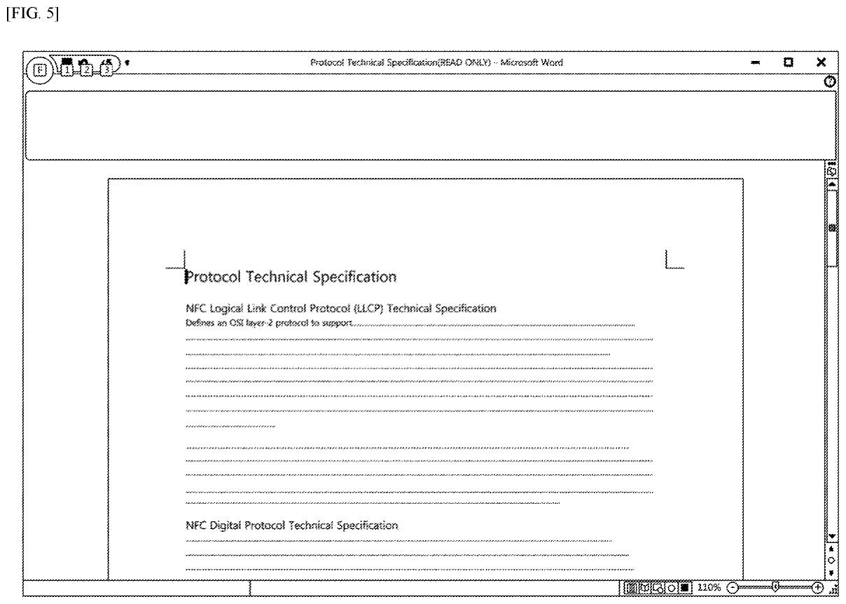

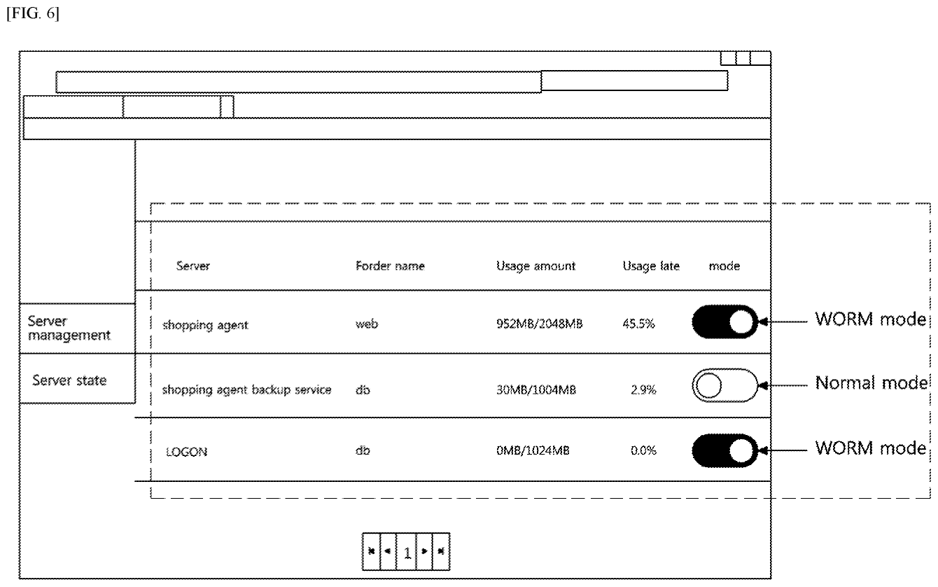

FIG. 1 is an overall block diagram of a system for providing a hybrid WORM disk including a network file server and a PC on which a client program is installed and FIGS. 2 and 3 are reference diagrams for describing a system for providing a hybrid WORM disk according to an embodiment of the present invention. 4 is an example of an administrator page for setting a file change valid time, FIG. 5 is an example of opening a file as read-only while a WORM disk mode is operated in the system for providing the hybrid WORM disk, and FIG. 6 is an example of a mode setting administrator page for each folder. Hereinafter, the present invention will be described with reference to FIGS. 2 to 6 based on a block diagram of the system of FIG. 1.

In the present specification, the present invention will be described based on a case where a user terminal such as a PC is session-connected to a network file server, but it will be apparent that the present invention may be implemented in the same or similar manner as the following description even when a service server is session-connected to the network file server. That is, the present invention may be applied equally even to a case where a user PC OS and a service server based on a Linux or Unix system use data by mounting a specific storage space of the network file server.

In addition, various file create and close functions may exist in every operating system file system. For example, even in the case of a Windows operating system, when a file is created, the file may be created as Openfile( ) and Createfile( ), and even when the file is closed, the file may be closed as Close( ) and Closefile( ). Therefore, the present specification will be described based on an overall operating procedure rather than being faithful to every command one by one.

Referring to FIG. 1, a network file server (NFS) client is installed in a personal computer (PC) of a user. The PC of the user is communicatively connected with a remote network file server (hereinafter, referred to as NFS) through the network file server client.

In the embodiment of the present invention, user authentication is performed by running a network file server client program (NFS User Client Program in FIG. 1) so as to check whether the user is a normal user. Since such a user authentication process, and the like do not correspond to the core technical features of the present invention, a detailed description thereof will be omitted.

When the user authentication as described above is normally completed, a storage space of the network file server (NFS) may be mounted as a drive of the PC through a custom file system driver installed in the PC. In the embodiment of the present invention, the disk drive mounted on the PC is a virtual drive in the form of a network drive, and functions as a hybrid WORM drive capable of operating in any one of a general disk mode (that is, a state of operating as a disk drive in which read/write is possible), a Write Once Read Many (WORM) disk mode, and a Read-Only disk mode according to the settings of the administrator or the user. That is, according to the embodiment of the present invention, the hybrid WORM disk is provided by the network file server to allow mode switching between the general disk mode, the WORM disk mode, and the read-only disk mode according to the settings through an administrator page or the user's settings on an NFS client screen. At this time, the custom file system driver of FIG. 1 may be implemented using FUSE in a Linux or Unix operating system depending on an OS, and the Windows may be implemented using a Dokhan or CallBack file system driver or directly implemented. It will be apparent that that the NFS user client program operating on the corresponding driver may be developed to provide an interface according to the OS.

A typical example of an existing WORM disk is a physical disk medium such as a CD ROM or DVD ROM. Accordingly, once the existing WORM disk operates only as read-only after once written, and thereafter, changes such as creation, modification, deletion, and the like of the data were impossible unless a separate hardware device such as a CD ROM writer is used. On the other hand, in the hybrid WORM disk provided according to the embodiment of the present invention, the switching between the WORM disk mode and the general disk mode is possible by software. Accordingly, when operating in the WORM disk mode, the hybrid WORM disk may provide convenience such as file change by the user when switched to the general disk mode, as well as safety to external attacks such as ransomware, etc. when operating in the WORM disk mode. Hereinafter, specific implementation methods for the system for providing the hybrid WORM disk according to the embodiment of the present invention will be described.

While the disk drive operates in the WORM disk mode, when an open request for the corresponding file is received from the NFS client after the change valid time has elapsed, the network file server may be implemented to provide the open-requested file only as read-only. That is, in the WORM disk mode, in all cases that are not subject to a specific condition to be described below, the disk drive operates only as read-only, and thus, it is impossible to create a file or folder with an identical name. However, as a specific condition, in the following cases, it is possible to change (for example, write, modify, delete, move, rename, etc.) a file (including a folder) with an identical name even when operating in the WORM disk mode. Of course, in the general disk mode, creating, reading, modifying, and deleting of the file or the folder are all possible without any special restrictions.

That is, according to the embodiment of the present invention, while the disk drive operates in the WORM disk mode, when the file creation request is received from the NFS client, the disk drive mounted in the form of a network drive on the PC of the user through interworking between the NFS client and the network file server may check whether a file with an identical file name exists and allow the corresponding file to be created or changed (modified) within a preset change valid time if no identical file exists. On the other hand, if it is checked that a request to create an existing file with an identical name, not a new file, has been received from the NFS client, the network file server rejects the request and may send an error message that an identical file exists or there is no permission to the NFS client.

In an embodiment, whether the request to create the corresponding file is a request to create a new file may be checked in the following method. For example, the network file server checks whether an identical file exists based on a file creation requester identifier (ID), a file path, and a file name included in the file creation request received from the NFS client, and may allow the creation of the corresponding file within the change valid time range based on a first file creation request time of the corresponding file when the identical file exists.

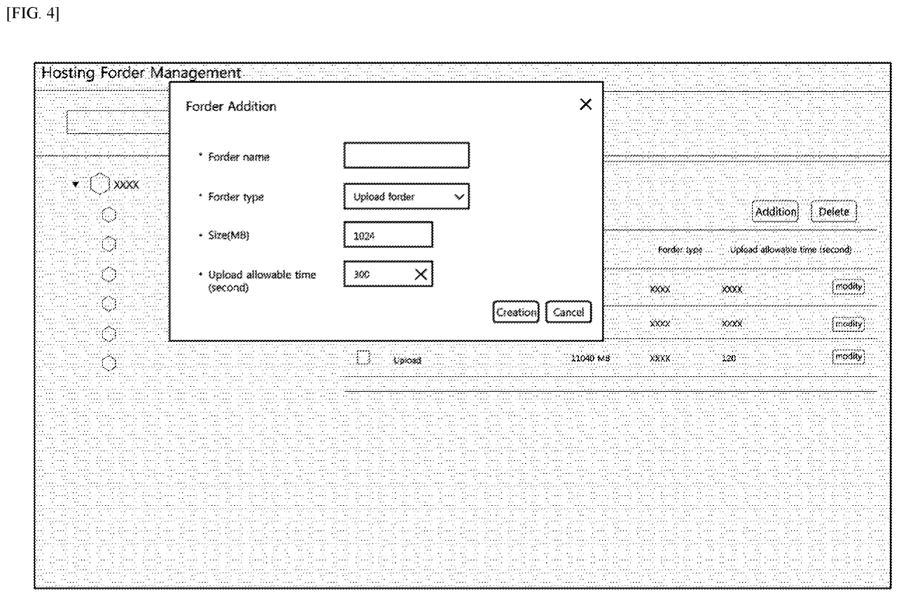

As such, the reason for determining whether to allow a file change based on a specific file change valid time is as follows. In general, when a file is created in a disk drive, there is no method to check when the creation of the file is completed. Therefore, in the embodiment of the present invention, by reflecting the difficulty of checking when the file data transmitted through the network is terminated, generally (or statistically), the embodiment is implemented to set a time required for creating the file (or a time considering some buffer time therein), and the like as the change valid time according to a type or attribute of the corresponding file or a type or attribute of a program creating the corresponding file and then enable the creation (or change) of the file only within the time. The setting of such a change valid time may be performed by the administrator directly through the administrator page as illustrated in FIG. 4, by the user directly through a screen provided through an NFS client although not clearly illustrated in the drawing, or by the user, or automatically to a specified time according to the type/attribute of the file described above, the type/attribute of each program, or the like.

This change valid time may be separately managed in the memory in the network file server. In this case, the memory may be a fast volatile memory, a file, or a database (DB). As another example, the change valid time may be managed based on a file time existing in the file system. In particular, the following method may be used as an implementation method that does not store the valid time in a separate memory when managing a changeable valid time to the file creation request time. For example, whenever a file is created, the change valid time of the film may also be managed without a separate memory management by comparing a current time based on the creation time or the modification time of the file written in an attribute value of the file.

Further, according to an embodiment, while the disk drive operates in the WORM disk mode, when any one file change request among writing, modifying, deleting, moving, and name changing of the file is received from the NFS client, the network file server may check whether a file requested to change the file exists, check whether the change valid time has elapsed if the corresponding file exists, allow the change according to the file change request if the change valid time has not elapsed, and send a message for rejecting change according to the file change request to the NFS client if the change valid time has elapsed.

Here, in addition to the aforementioned examples, of course, the file change request may further include requests for, for example, file encryption, file time change, file text content change, file binary value change, etc.

In addition, according to an embodiment, any one of the general disk mode and the WORM disk mode is able to be set for the entire disk drive, or separately set for each basic folder in the disk drive or for each subfolder in the basic folder (see FIG. 3).

That is, according to the method of implementing an operation state value of the network file server, not only the operation state value of the basic folder connected to the client is set, but also the permission may be separately set for each subfolder. For example, although a parent folder operates in the WORM disk mode, some of the subfolders may be set to the general disk mode. In the case of a web server, a web server source code does not need to be changed, but a log folder exists at the bottom of the source folder, but there are cases where the source code should be changed from time to time. Unlike this, of course, it is also intended to provide convenience for an administrator or a user to select the WORM disk mode and the general disk mode as needed. To this end, when the network file server manages a file list, a function of managing a separate operation setting mode for each folder by file path may be added to the disk administrator screen.

Hereinabove, the case has been mainly described in which when the file creation request is received in the warm disk mode, the file change valid time is used to determine whether or not to create a file. However, when the file creation request or the file change request is received, there is a limitation to first check whether the request is the creation or change request by a predetermined program, and then determine whether to create/change the file according to the file change valid time only when the request is the creation or change request by the predetermined program. For example, in FIG. 1, the custom file system driver of the NFS client sends an identification value of the program requested to create and change the file to the network file server together. In this case, a network file server daemon may subsequently perform the above-described procedure only when the received program identification value is equal to a predetermined program identification value.

In addition, according to an embodiment of the present invention, while the corresponding disk drive mounted in the form of a network drive operates in the WORM disk mode, when a process which is not registered in advance in the user terminal or the service server is detected, the network file server may block the corresponding disk drive or prohibit the reading of files in the disk drive, thereby effectively blocking attacks by processes such as malware that are not registered in advance.

More specifically, when a process not specified in advance in the service server is driven by reviewing a process history in real time or periodically, when the service server recognizes the process as an abnormal program detection and notifies the abnormal situation to the file server, the file server stops a currently connected network drive or may respond to a terminal connected with no file or no read permission even if a file list or an open command comes in from the connected network drive.

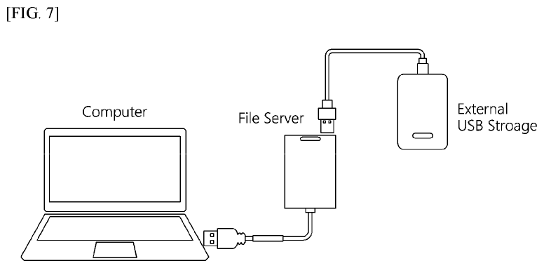

In addition, according to the embodiment of the present invention, the hybrid WORM disk may be configured detachablely. This is illustrated through FIGS. 7 to 9.

Recently, as ransomware and various malware attacks against PCs and servers are increasing, the back-up of data has been activated by mounting an external USB storage or a network attached storage (NAS) on a computer as a mobile drive or a network drive. Accordingly, there is a need for a method of implementing the system for providing the hybrid WORM disk according to the embodiment of the present invention while using such an external USB storage or NAS as it is.

However, according to the related art, even if a new storage is connected to the file server, only when the file server needs to be configured to use a newly installed storage, the newly installed storage may be mounted as a drive on the computer connected to the file server, and as a result, it was difficult to use a device such as external USB storage, which is frequently detached, as the external storage of the file server. Therefore, when using the system for providing the hybrid WORM disk of the present invention to securely protect the data of the computer from ransomware or malware attacks, whenever an existing external USB storage or NAS is connected to the file server, there is a need for a new method that can be used automatically on the computer without the need to separately change the settings of the file server.

Thus, hereinafter, a method of utilizing an external USB storage or NAS as the hybrid WORM disk according to the embodiment of the present invention will be described below with reference to FIGS. 7 to 9. Therefore, hereinafter, a method for automatically mounting an external USB storage or NAS newly recognized in the file server as a network drive of a computer connected to the file server will be described.

FIG. 7 is a conceptual diagram of an embodiment for describing a method and a system in which a computer and a file server are connected to a network constituted by a USB medium and a new external USB storage is connected to the file server to be automatically mounted on a computer as a network drive device.

In this case, the file server may also be a fixed-type large server depending on the configuration, but it will be also apparent that the file server may be configured as a smallest one-chip portable computing device such as a Raspberry Pi mini, and may be a lightweight server driven only by USB power of a computer.

In addition, when configuring the file server with the smallest one-chip computer, it will be apparent that a small memory such as a flash memory or an SD memory, not a hard disk type storage with a motor, may be installed as a storage of the file server to be provided as a storage of the file server, and it will be apparent that an external storage may be connected to the file server using a USB port or a network port in addition to a built-in storage.

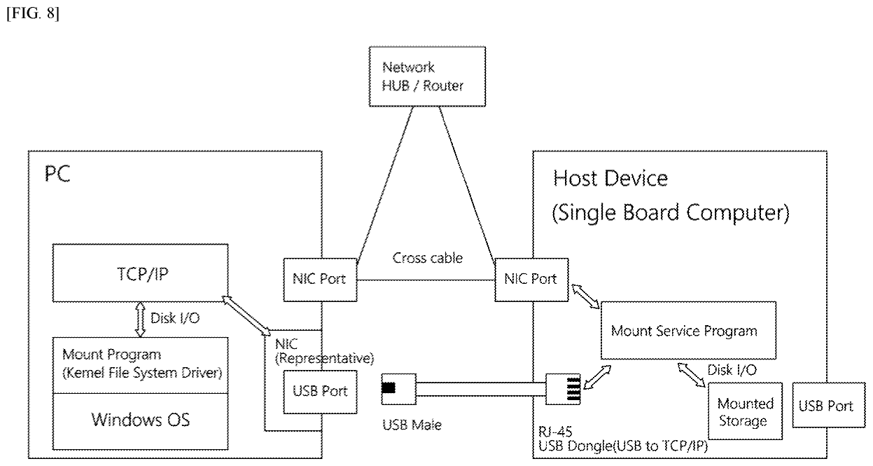

FIG. 8 is a diagram of an embodiment for describing a configuration connected between a computer and a file server and a configuration to which a file server and a new storage are connected. FIG. 8 illustrates a method in which the file server is configured as a smallest single board computer and then connected to the computer through a network or connected by replacing the network with a USB port. At this time, it will be apparent that a medium connected to the computer and the file server is connected through a network, but a physical method may be connected through various communication media such as wireless, wired, USB, serial, and parallel.

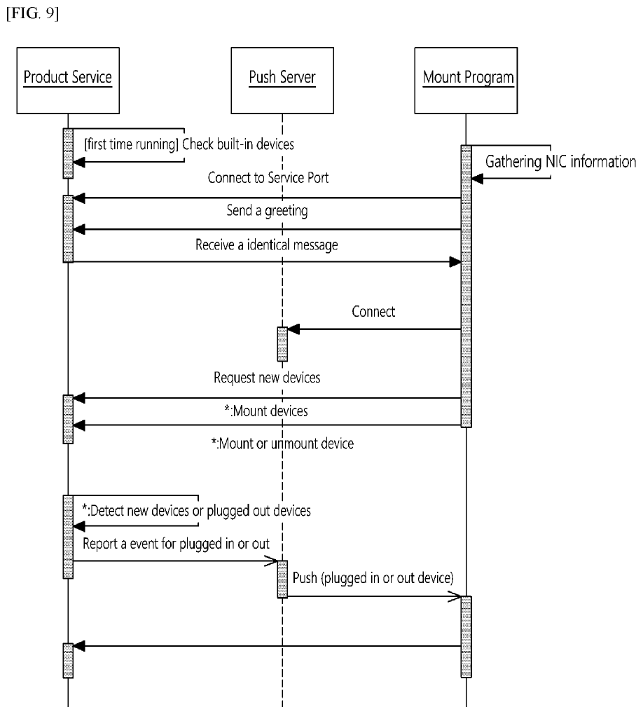

FIG. 9 is a flowchart illustrating how a product service and a push server driven in a file server receive a drive list and initiates a connection with a mount program driven in a computer.

Here, the product service and the push server are modules running on the file server device, and the mount program is a module running on the computer. The product service and the push server are daemons that start automatically when the file server boots. The product service performs creation, storage, modification, and deletion of files requested by the computer, and the push server serves to send a Push event to the mount program when a new USB device is plugged in or plugged out to the file server.

When the product service is first executed after installation, the product service searches and stores storage devices that are already held by the file server, and detects whether a new USB or network storage is connected or disconnected based on this. It will be also apparent that a detection period may be real-time or a predefined period.

The mount program in the computer operates as an OS service rather than an executable program and may start automatically when booting. The mount program is connected to the push server upon startup.

At this time, the mount program may also try to be connected to a predefined network address. When the network address is not predefined, in order to obtain an IP address of the file server, information on all network cards (NIC) installed in the PC is examined and then broadcasted to a D class address band of the IP address assigned to each NIC. Alternatively, the mount program is connected to a service port of the product service while changing from 0 to 255, and then may send a predefined Greeting message and check whether a predetermined response is returned to find the file server.

In this way, after the mount program finds the address of the file server, the mount program is connected to the push server in the file server, obtains a storage list held by the file server, and then performs a Mount request to the product service to mount the drive on the PC. This operation occurs repeatedly as many times as the number of storages connected to the file server.

The product service detects a USB or network storage that is newly connected or disconnected after driving. This is performed using a Linux C function called inotify and monitors a /dev/ folder. All devices of Linux exist in the form of files under the /dev/ folder, and when a new USB storage is connected or disconnected, the corresponding device file is created under /dev/ or the existing device file is deleted. If it is detected that a new USB storage has been connected or disconnected, the product service notifies the fact to the mount program through the push server, and the mount program receiving the fact performs a Mount or Unmount request to the product service or directly disconnects the mounted drive.

The Mount/Unmount operation of the PC is actually performed by the mount program itself, and the mounted drive's I/O is requested to the product service to be executed, and operations of receiving the results and returning to the computer OS are performed.

In addition, in the embodiment of the present invention, a USB port or a wired/wireless network Ethernet port may be connected to the file server and the computer, and it will be apparent that a user authentication step between the file server and the computer may be added to check whether the user is an authorized user or not when running the mount program for connection.

In addition, in the embodiment of the present invention, it will be apparent that the file server may be a general file server or a special file server that can create, but cannot modify or delete a general storage, like a Write Once Read Many (WORM) storage.

In addition, in the embodiment of the present invention, it will be apparent that when the file server is connected to a storage or a computer, it is possible to connect the storage or the computer by switching a USB port to a communication medium instead of a network.

In addition, in the embodiment of the present invention, when the external storage is connected to the file server device, the drive is automatically mounted on the computer. It will be apparent that the method of mounting the drive by the mount program is not limited to a single drive mount technology dependent on a specific OS, such as a mobile disk, a local disk, or a network disk.

Accordingly, when the existing external USB storage or NAS storage is connected to the computer via the file server to be used as a storage device, the storage may be automatically mounted/unmounted as a network drive in the computer without requiring separately setting change or restarting of the computer or the file server.

In addition, in the embodiment of the present invention, it will be apparent that the file server may encrypt and store the file when storing the file, and decrypt and provide the file when opening the file. A configuration to be encrypted and decrypted by a predefined encryption/decryption algorithm may be set by the administrator. As the example, when implemented as a lightweight file server using a USB port, there is an advantage that the connected USB storage is encrypted like a secure USB, so that the USB storage is lost and data is not disclosed.

The method for providing the hybrid WORM disk according to the embodiment of the present invention is able to be implemented as a computer readable code in a computer readable recording medium. The computer readable recording medium includes all kinds of recording media storing data which may be deciphered by a computer system. For example, the recording medium may include a read only memory (ROM), a random access memory (RAM), a magnetic tape, a magnetic disk, a flash memory, an optical data storage device, etc. Further, the computer readable recording medium may be stored and executed as codes which may be distributed in the computer system connected through a computer communication network and read by a distribution method.

Hereinabove, the present invention has been described with reference to the embodiments of the present invention, but it will be easily appreciated by those skilled in the art that various modifications and changes of the present invention can be made without departing from the spirit and the scope of the present invention which are described in the appended claims.

1. A system for providing a hybrid WORM disk comprising:
a network file server; and a network file server (NFS) client installed in a user terminal or a service server and communication-connected with the network file server which is remotely positioned,
wherein the network file server has a mode setting function which allows a disk drive, which is mounted in the form of a network drive in the user terminal or the service server, to operate in any one of a general disk mode in which creating, reading, modifying, deleting, and the like are possible, and a Write Once Read Many (WORM) disk mode in which only creating and reading are possible, and
while the disk drive operates in the WORM disk mode, when the file creation request is received from the NFS client, the network file server checks whether a file with an identical filename exists and allows the corresponding file to be created within a preset change valid time range if no identical file exists.

2. The system for providing the hybrid WORM disk of claim 1, wherein while the disk drive operates in the WORM disk mode, when the file creation request is received from the NFS client,
the network file server checks whether an identical file exists based on a file creation requester identifier (ID), a file path, and a file name included in the file creation request, and allows the creation of the corresponding file within the change valid time range based on a first file creation request time of the corresponding file when the identical file exists.

3. The system for providing the hybrid WORM disk of claim 1, wherein while the disk drive operates in the WORM disk mode, when any one file change request among writing, modifying, deleting, moving, and name changing of the file is received from the NFS client,
the network file server checks whether a file requested to change the file exists, checks whether the change valid time has elapsed if the corresponding file exists, allows the change according to the file change request if the change valid time has not elapsed, and rejects the change according to the file change request to the NFS client if the change valid time has elapsed.

4. The system for providing the hybrid WORM disk of claim 1, wherein while the disk drive operates in the WORM disk mode, when an open request for the corresponding file is received from the NFS client after the change valid time has elapsed, the network file server provides the open-requested file only as read-only.

5. The system for providing the hybrid WORM disk of claim 1, wherein any one of the general disk mode and the WORM disk mode is able to be set for the entire disk drive, or separately set for each basic folder in the disk drive or for each subfolder in the basic folder.

6. The system for providing the hybrid WORM disk of claim 1, wherein the change valid time is able to be set independently for each type or attribute of the corresponding file or for each type or attribute of an application program of creating the corresponding file.

7. The system for providing the hybrid WORM disk of claim 1, wherein while the disk drive operates in the WORM disk mode, when a process which is not registered in advance in the user terminal or the service server is detected,
the network file server blocks the disk drive mounted in the form of a network drive or prohibits the reading of files in the disk drive.

8. A detachable hybrid WORM disk comprising:
a file server which is installed on a separate device from a computer on which a storage drive is to be mounted, mounted with a push server for transmitting a list of storage devices to be connected to the computer after querying a storage device connected in the device, and mounted with a product service for providing a drive service for each storage device when requesting a drive connection of a mount program in the computer; and
a mount program which is installed on the computer on which the drive is to be mounted, receives a list of storage devices to request a connection to the file server, requests the connection to the file server for each storage device, and receives a drive service.

9. The detachable hybrid WORM disk of claim 8, wherein when the file server is connected to the computer, the file server is able to be connected through an Ethernet network, or connected by switching the network to an emulated USB medium.

10. The detachable hybrid WORM disk of claim 9, wherein when a USB storage is additionally connected to the file server, the file server automatically recognizes that the storage device is added and sends additional storage information to the connected computer, and then, when the computer requests to mount a new device for automatic connection of an additional storage, the file server connects the storage area to be mounted as a new drive on the computer.

11. The detachable hybrid WORM disk of claim 10, wherein when the storage which has been connected to the file server is disconnected, the file server recognizes the disconnection of the storage, sends information on the disconnected storage to the connected computer, and then unmounts the drive which has been connected to the corresponding storage on the computer.
